(19) United States
(12) Patent Application Publication
(10) Pub. No.: US 2009/0083756 A1
(43) Pub. Date: Mar. 26, 2009

(54) APPARATUS AND METHOD FOR COMMUNICATION INTERFACE BETWEEN APPLICATION PROGRAMS ON VIRTUAL MACHINES USING SHARED MEMORY

(75) Inventors: Kang-Ho KIM, Daejon (KR); Chei-Yol KIM, Gumi-si (KR); Sung-In JUNG, Daejon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejon (KR)

(21) Appl. No.: 12/099,949

(22) Filed: Apr. 9, 2008

(30) Foreign Application Priority Data
Sep. 20, 2007 (KR) 10-2007-0095770

(51) Int. Cl. G06F 9/54

(52) U.S. Cl. 719/312

(57) ABSTRACT

Provided are an apparatus and a method for communication interface between application programs on virtual machines using a shared memory. The apparatus, includes: a request dividing unit for checking a type of socket request information transmitted from a first socket application program on a first virtual machine through a socket interface and dividing the socket request information based on the checked information; a Transmission Control Protocol (TCP) socket connecting unit setting up TCP socket connection with a second socket application program on a second virtual machine based on the divided socket request information for control request; and a shared memory connecting unit for setting up shared memory connection through the set up TCP socket connection and transmitting/receiving data with the second socket application program through the set up shared memory connection based on the divided socket request information for data transmission/reception.

### CROSS-REFERENCE TO RELATED APPLICATIONS

The present invention claims priority of Korean Patent Application No. 10-2007-0095770, filed on Sep. 20, 2007, which is incorporated herein by reference.

### BACKGROUND OF THE INVENTION

1. Field of the Invention

The present invention relates to an apparatus and a method for communication interface between application programs on virtual machines using a shared memory; and, more particularly, to a communication interface apparatus and method for improving communication performance between application programs on virtual machines by reducing overhead generated by a conventional socket interface. The overhead can be reduced by dividing a socket request between application programs on the virtual machine into a transmission/reception data request and a control request, and processing data using a memory shared in the virtual machines around a conventional socket interface upon a request for transmission/reception data.

This work was supported by the Information Technology (IT) research and development program of the Korean Ministry of Information and Communication (MIC) and the Korean Institute for Information Technology Advancement (IITA) [2005-S-119-02, “The Development of Open S/W Fundamental Technology”].

2. Description of Related Art

Recently, advancement of a virtual machine technology includes application of the virtual machine technology to servers. A plurality of virtual machines are installed in an actual machine and each virtual machine is loaded with an independent operating system. A service is provided by installing a necessary application program to each system. Accordingly, in an environment that a plurality of virtual machines are operated in the same actual machine, the quantity of data that a socket application program of a virtual machine communicates with an application program of another virtual machine through a socket interface is increasing.

A communication interface is required when an application program of a virtual machine communicates with an application program of another virtual machine. For example, a conventional socket interface developed in University of California in Berkeley is generally used as a representative communication interface. The socket interface will be described with reference to FIG. 1.

FIG. 1 illustrates a conventional software layer for socket communication. FIG. 1 shows the software layer that a communication packet should pass through on each virtual machine in use of the socket interface in the socket application program of the virtual machine. The socket interface is connected to the application program in a library format.

Referring to FIG. 1, the conventional software layer for socket communication includes a socket interface 120 on a first socket application program 110 and a network interface card 130. Also, a software layer on a second socket application program 150 includes a socket interface 160 and a network interface card 170. Each of the socket interfaces 120 and 160 includes library layers 121 and 161, system call layers 122 and 162, Virtual File System (VFS) layers 123 and 163, kernel socket layers 124 and 164, Transmission Control Protocol (TCP) layers 125 and 165, and Internet Protocol (IP) layers 126 and 166.

To have a look at an operation of the conventional software layer for socket communication, the first socket application program 110 calls a data transmission function based on the socket interface of the library layer 121. Subsequently, data on the data transmission function are transmitted to a network interface card (NIC) 130 through the Berkeley Software Distribution (BSD) layer 122, which is the system call layer inside the operating system kernel, the INET layer 124, which is the kernel socket layer, the TCP layer 125, the IP layer 126, and a network interface card driver 127.

The network interface card 170 related to another second socket application program 150 on virtual machines receives the data transmitted from the network interface card 130 through a network. Subsequently, the data are processed in a reverse direction of the procedure performed in the first socket application program 110 and transmitted to the second socket application program 150.

When the data are transmitted from the first socket application program 110 to the second application program 150, the data are transmitted to the second socket application program 150 in another virtual machine after going through a plurality of layers. A Transmission Control Protocol/Internet Protocol (TCP/IP) related to the TCP layer 165 and the IP layer 166 is suggested for a Wide Area Network (WAN) environment. The TCP/IP protocol includes a plurality of functions for a reliable packet transmission/reception between both communication ends. However, when the TCP/IP protocol performs the functions, the quantity of data processes increases or the amount of Central Processing Unit (CPU) used for processing complicated data increases.

FIG. 2 is a diagram showing a conventional communication configuration between application programs on different virtual machines.

Referring to FIG. 2, there are application programs such as a domain 0 210, a Web server 220, an application server 230, and a database server 240 on one hardware. Each of application programs 210, 220, 230 and 240 is connected to each of the first, second, third and fourth virtual machines 211, 221, 231 and 241. The application programs 210, 220, 230 and 240 are operated on the same hardware 200.

When it is assumed that the domain 0 210 functions as an operating system managing an entire device and the application server 230 is to communicate with the database server 240, a communication packet of the application server 230 should go through a kernel protocol stack (not shown) on the third virtual machine 231, a switch module 201 on the first virtual machine 211, and a kernel protocol stack (not shown) on the fourth virtual machine 241.

The socket communication between application programs on different virtual machines on the same hardware is not supported in case of the conventional virtual machine.

### SUMMARY OF THE INVENTION

A conventional communication interface technology between application programs on virtual machines has a problem in that socket communication between application programs on virtual machines is inefficiently performed. The present invention is directed to solve the problem that an unnecessary data process quantity and a process time increase since the conventional technology performs socket communication with a Transmission Control Protocol/Internet Protocol (TCP/IP) layer used in communication between application programs on virtual machines which are dependent from one another, through a switching module.

An embodiment of the present invention is directed to providing apparatus and method for communication interface between application programs on virtual machines using a shared memory by reducing overhead generated by a conventional socket interface by dividing a socket request between application programs on the virtual machine into a transmission/reception data request and a control request, and processing data using a memory shared in the virtual machines around a conventional socket interface upon a request for transmission/reception data.

The objects of the present invention are not limited to the above-mentioned ones. However, other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

To solve the above problem, the present invention divides a socket request between application programs on the virtual machine into a transmission/reception data request and a control request and processes data using a memory shared in the virtual machines around a conventional socket interface upon a request for transmission/reception data.

In accordance with an aspect of the present invention, there is provided an apparatus for communication interface between application programs on virtual machines, including: a request dividing unit for checking a type of socket request information transmitted from a first socket application program on a first virtual machine through a socket interface and dividing the socket request information based on the checked information; a Transmission Control Protocol (TCP) socket connecting unit setting up TCP socket connection with a second socket application program on a second virtual machine based on the divided socket request information for control request; and a shared memory connecting unit for setting up shared memory connection through the set up TCP socket connection and transmitting/receiving data with the second socket application program through the set up shared memory connection based on the divided socket request information for data transmission/reception.

In accordance with another aspect of the present invention, there is provided a method for communication interface between application programs on virtual machines, including the steps of: checking a type of socket request information transmitted from a first socket application program on a first virtual machine through a socket interface and dividing the socket request information based on the checked information; setting up Transmission Control Protocol (TCP) socket connection with a second socket application program on a second virtual machine based on the divided socket request information for control request; setting up shared memory connection through the set up TCP socket connection; and transmitting/receiving data with the second socket application program through the set up shared memory connection based on the divided socket request information for data transmission/reception.

### BRIEF DESCRIPTION OF THE DRAWINGS

FIG. 1 illustrates a conventional software layer for socket communication.

FIG. 2 shows a conventional communication configuration between application programs on different virtual machines.

FIG. 3 is a block diagram describing a communication interface method using a shared memory between application programs to which the present invention is applied.

FIG. 4 is a block diagram showing a communication interface apparatus between application programs on virtual machines using a shared memory in accordance with an embodiment of the present invention.

FIG. 5 is a block diagram showing TCP socket connection and shared memory connection between sockets in accordance with an embodiment of the present invention.

FIG. 6 is a flowchart describing a communication interface method between application programs on virtual machines using a shared memory in accordance with an embodiment of the present invention.

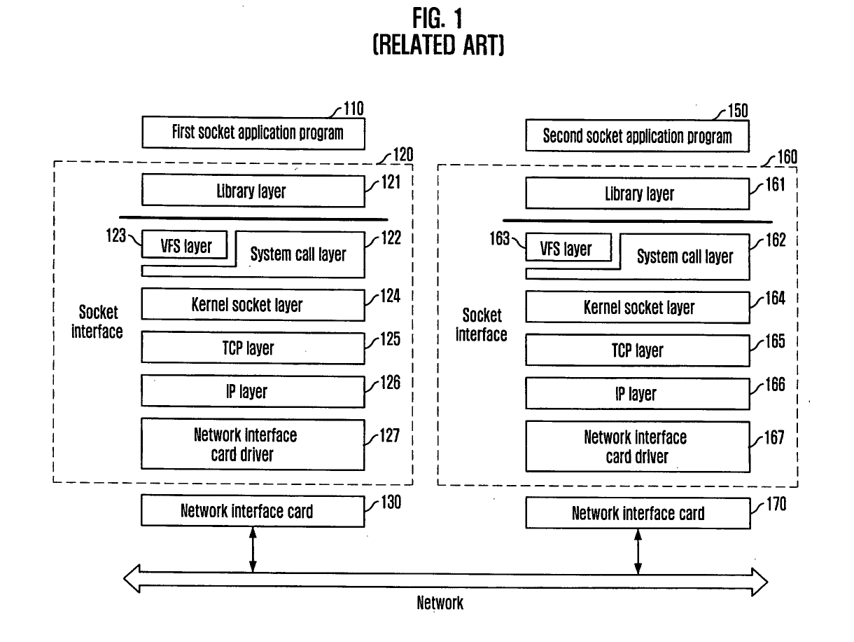

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

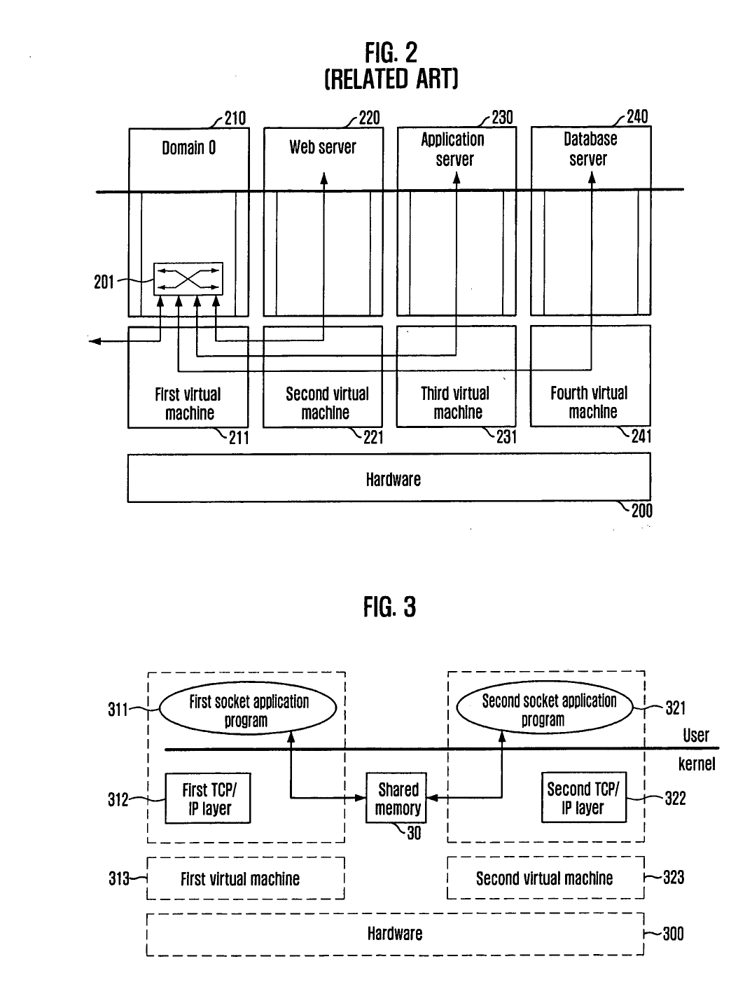

FIG. 3 is a block diagram showing a communication interface method using a shared memory between application programs to which the present invention is applied.

A communication interface apparatus using a shared memory 30 between the first socket application program 311 and the second socket application program 321 will be described with reference to FIG. 3.

Referring to FIG. 3, the first socket application program 311 is connected to a first Transmission Control Protocol/Internet Protocol (TCP/IP) layer 312 and a first virtual machine 313. The second socket application program 321 is connected to a second TCP/IP layer 322 and a second virtual machine 323. The first socket application program 311 and the second socket application program 321 are operated on the same hardware 300.

That is, there are the first and second virtual machines 313 and 323 based on one hardware 300. Referring to FIG. 3, the first and second socket application programs 311 and 321 directly perform communication using a shared memory 30 without going through the first and second TCP/IP layers 312 and 322.

To have a look at a process of each socket request based on each software configuration, the first socket application program 311 calls a connection function and creates TCP/IP socket connection with the second socket application program 321 through the first TCP/IP layer 312, the first virtual machine 313, the second virtual machine 323, and the second TCP/IP layer 322. The first socket application program 311 creates shared memory connection using the shared memory 30 through the TCP/IP socket connection.

Subsequently, the first socket application program 311 transmits/receives data with the second socket application program 321 through the shared memory connection using the shared memory 30 without going though the first and second TCP/IP layers 312 and 322. That is, the first socket application program 311 records data in the shared memory 30. An event that data are recorded in the shared memory 30 is transmitted to the second socket application program 321 and the second socket application program 321 reads the data recorded in the shared memory 30. A data transmitting procedure using the shared memory may be performed differently according to a quantity of the shared memory or an access method.

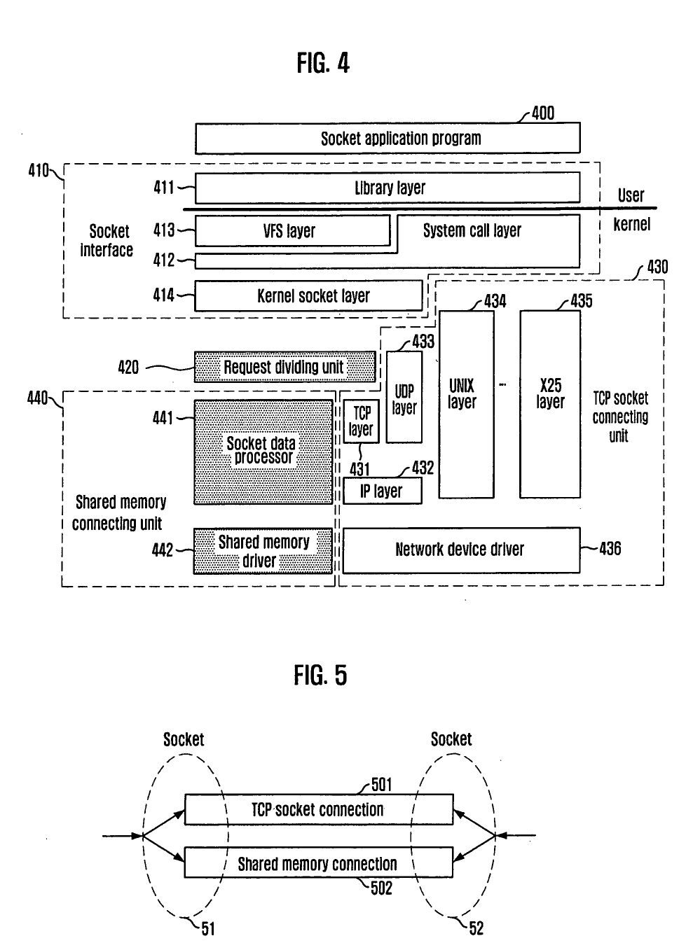

FIG. 4 is a block diagram showing a communication interface apparatus between application programs on virtual machines using a shared memory in accordance with an embodiment of the present invention.

Referring to FIG. 4, the communication interface apparatus between application programs on virtual machines using shared memory in accordance with the present invention includes a socket interface 410, a request dividing unit 420, a TCP socket connecting unit 430, and a shared memory connecting unit 440.

The socket interface 410 includes a library layer 411, a system call layer 412, which is a Berkeley Software Distribution (BSD) socket, a VFS layer 413, and a kernel socket layer 414, which is an INET layer.

Also, the TCP socket connecting unit 430 includes a TCP layer 431, an IP layer 432, a User Datagram Protocol (UDP) layer 433, a UNIX layer 434, an X25 layer 435, and a network device driver 436. The shared memory connecting unit 440 includes a socket data processor 441 and a shared memory driver 442.

Each constituent element of the communication interface apparatus in accordance with the present invention will be described in detail hereinafter.

When a socket application program 400 calls a socket Application Program Interface (API), a socket function is called in the library layer 411 and the system call layer 412 of the corresponding socket interface 410. A next called function is determined according to a protocol designated in the socket. For example, when the protocol designated in the socket is ‘STREAM_SOCK’ of kernel socket layer (PF_INET) 414, a function related to shared memory communication is called. Otherwise, a pre-designated protocol process function is called. The system call layer 412 and the kernel socket layer 414 are used in the conventional format for each realization and socket compatibility.

The request dividing unit 420 checks a type of socket request information transmitted from the socket application program 400 on virtual machines through the socket interface 410 and is divided into the TCP socket connecting unit 430 or the shared memory connecting unit 440 according to the checked information type. The request dividing unit 420 classifies the socket request information into socket request information for data transmission/reception and socket request information for socket control and divides the socket request information according to each request. When an opposite virtual machine on another hardware is connected, the request dividing unit 420 creates only a TCP/IP socket, but does not create shared memory connection. The socket application program 400 considers the TCP socket connection and the shared memory connection as one socket connection.

The socket request information for data transmission/reception is divided to the shared memory connecting unit 440 and the socket request information for socket control is divided to the TCP socket connecting unit 430. For example, the socket request information for data transmission/reception means all requests related to ‘send’, and ‘recv’ socket functions. The socket request information for socket control is request information on connection, accept, listen, bind, close, select, poll, shutdown, ‘setsocktop’, and ‘getsockopt’ which means request information having no relation with actual data transmission/reception.

The TCP socket connecting unit 430 sets up TCP socket connection with a socket application program on another virtual machine according to the socket request information for control request divided by the request dividing unit 420, i.e., the TCP/IP protocol.

For example, the TCP socket connecting unit 430 requests TCP socket connection with the socket application program on another virtual machine based on the connection request information among the socket control information divided by the request dividing unit 420. Subsequently, a socket connecting unit on another virtual machine processes the connection request information, sets up TCP socket connection, and searches shared memory connection related to the TCP socket connection. When the apposite socket application program 400 requesting connection is a socket application program on another virtual machine, only TCP socket connection is created since there is no related shared memory connection. The socket connection is completed by accepting the connection request information.

When the TCP socket connection is set up in the TCP socket connecting unit 430, the shared memory connecting unit 440 sets up shared memory connection with a socket application program on another virtual machine. For example, the shared memory connecting unit 440 sets up shared memory connection with the socket application program on another virtual machine based on connection request information among the socket request information divided by the request dividing unit 420.

To have a look at the shared memory connecting unit 440 in detail, the socket data processor 441 sets up shared memory connection through the set up TCP socket connection, and controls read/write of transmission/reception data of the shared memory driver 442 based on the socket request information for data transmission/reception divided by the request dividing unit 420. That is, the socket data processor 441 transmits/receives data by controlling the shared memory driver 442. The socket data processor 441 processes diverse socket options designated when data transmission/reception is requested according to the meaning of the socket request. The option includes asynchronous IO, block IO, non-block IO, and MSG_PEEK.

When there is no recording space in a shared memory, the shared memory connecting unit 440 can be processed differently according to the socket option. For example, when the socket option is non-blocking, the shared memory connecting unit 440 stops data transmission and notifies the transmission error information to the socket application program 400. When the option is blocking, the shared memory connecting unit 440 waits until there is a space for recording data and records the data. The shared memory connecting unit 440 may be performed differently according to the option.

On the other hand, when there is no data in the shared memory, the shared memory connecting unit 440 can be processed differently according to the socket option. For example, when the option is nonblocking, the shared memory connecting unit 440 stops fetching data and returns the read error information to the socket application program 400. When the option is blocking, the shared memory connecting unit 440 waits until there are data and fetches the data. The shared memory connecting unit 440 may be performed differently according to the option.

The shared memory driver 442 records or fetches transmission/reception data in the shared memory according to control of the socket data processor 441. That is, the shared memory driver 442 allocates the shared memory for shared memory communication records the data transmitted from the socket data processor 441 in the shared memory such that a shared memory connecting unit on an opposite virtual machine (not shown) can read the recorded data.

Also, when the shared memory driver 442 records or fetches the data in the shared memory, the shared memory driver 442 transmits an event signal to an opposite shared memory driver to notify the opposite shared memory driver that the shared memory data are changed. On the other hand, when the event signal is transmitted from the opposite shared memory driver (not shown), the shared memory driver 442 fetches data from the shared memory.

FIG. 5 is a block diagram showing TCP socket connection and shared memory connection between sockets in accordance with an embodiment of the present invention.

Referring to FIG. 5, two communication connections 501 and 502 are simultaneously connected between sockets 51 and 52 for one socket communication. That is, the shared memory connection 502 for a data transmitting/receiving process and the TCP socket connection 501 for transmitting a control request are maintained between the sockets 51 and 52, which are different from each other.

The communication interface apparatus in accordance with the present invention uses a conventional TCP socket connection 501 in the connection for control request and uses a shared memory connection 502 through the shared memory in the connection for data transmission/reception. This is a method for easily realizing shared memory communication while raising a data transmission speed since the data transmitting/receiving request and the control request are individually processed.

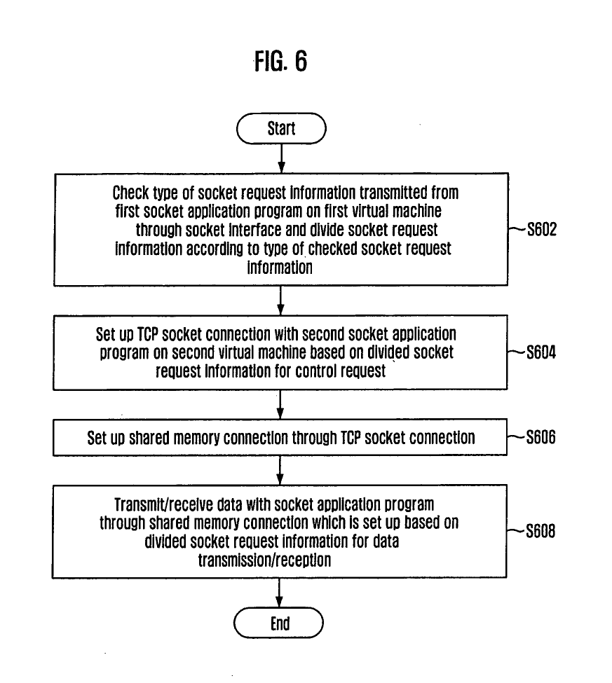

FIG. 6 is a flowchart describing a communication interface method between application programs on virtual machines using a shared memory in accordance with an embodiment of the present invention.

The request dividing unit 420 checks a type of called socket request information upon a socket request called by the socket application program 400 through the socket interface 410, and divides the socket request information according to the type of the checked socket request information at step S602.

The TCP socket connecting unit 430 sets up TCP socket connection with a socket application program on an opposite virtual machine based on the socket request information for the control request divided by the request dividing unit 420 at step S604. On the contrary, the TCP socket connecting unit 430 responds to the connection request of the opposite TCP socket connecting unit and searches shared memory connection related to the TCP socket connection.

The shared memory connecting unit 440 sets up shared memory connection through the set up TCP socket connection at step S606. When the opposite TCP socket connecting unit is on another machine, the shared memory connecting unit 440 creates only a TCP socket connection but does not create a shared memory connection.

The shared memory connecting unit 440 transmits/receives data with the socket application program on another virtual machine through the shared memory connection set up based on the socket request information for data transmission/reception divided by the request dividing unit 420 at step S608. When the data are recorded in the shared memory, the opposite shared memory connecting unit can receive an event signal and read the data. The shared memory connecting unit 440 collects only poll events related to the data with respect to the shared memory connection, and transmits the collected poll events to the socket application program 400. Also, the TCP socket connecting unit 430 collects only poll events related to control with respect to the TCP socket connection and transmits the collected poll events to the socket application program 400.

When there is no recording space in the shared memory, the process will be differed according to the socket option. For example, when the option is nonblocking, the shared memory connecting unit 440 stops data transmission and notifies transmission error information to the socket application program 400. When the option is blocking, the shared memory connecting unit 440 records the data after waiting until there is a space for recording data. The shared memory connecting unit 440 may be performed according to other options.

When the event signal is transmitted, the shared memory connecting unit 440 controls the shared memory driver 442 and reads the data in the shared memory. When the shared memory connecting unit 440 fetches the data in the shared memory, the opposite shared memory connecting unit receives the event signal and additionally uses the data.

When there is no data in the shared memory, the shared memory connecting unit 440 may be processed differently according to the socket option. For example, when the option is nonblocking, the shared memory connecting unit 440 stops fetching the data and returns read error information to the socket application program 400.

When the option is blocking, the shared memory connecting unit 440 waits until there are data and fetches the data. The shared memory connecting unit 440 may be performed according to other options.

As described above, the technology of the present invention can be realized as a program. A code and a code segment forming the program can be easily inferred from a computer programmer of the related field. Also, the realized program is stored in a computer-readable recording medium, i.e., information storing media, and is read and operated by the computer, thereby realizing the method of the present invention. The recording medium includes all types of recording media which can be read by the computer.

As described above, the present invention can improve communication performance, e.g., increase of bandwidth and reduction of data transmission delay time, by directly performing read/write of data using a shared memory. That is, the present invention directly transmits the data around a protocol process module such as TCP/IP and a switching module.

Also, since the present invention uses a shared memory only in data transmission in a communication protocol without correcting a conventional system call layer, the present invention can be easily realized and provide perfect binary socket compatibility.

The present invention can provide a standardized interface since the application program communicates through a conventional socket application program interface without determining whether a communication opponent is an internal virtual machine or an external virtual machine. When the data are transmitted, a proper function is automatically selected by grasping a location of an opposite division layer.

In the present invention, since a pre-formed socket program is not modified at all and is realized in a lower part of a communication process stack, an execution file can be used without modification. Also, the present invention can perform shared memory communication without changing a module using a socket inside a kernel as well as an application program.

Also, the present invention can easily support a socket API on high performance network interface, e.g., ‘TOE’, ‘Infiniband’, and ‘Myrinet’ only when a layer of the shared memory driver is changed.

While the present invention has been described with respect to the specific embodiments, it will be apparent to those skilled in the art that various changes and modifications may be made without departing from the spirit and scope of the invention as defined in the following claims.

What is claimed is:

1. An apparatus for communication interface between application programs on virtual machines, comprising:
a request dividing means for checking a type of socket request information transmitted from a first socket application program on a first virtual machine through a socket interface and dividing the socket request information based on the checked information;
a Transmission Control Protocol (TCP) socket connecting means for setting up TCP socket connection with a second socket application program on a second virtual machine based on the divided socket request information for control request; and
a shared memory connecting means for setting up shared memory connection through the set up TCP socket connection and transmitting/receiving data with the second socket application program through the set up shared memory connection based on the divided socket request information for data transmission/reception.

2. The apparatus of claim 1, wherein the request dividing means determines the type of the socket request information as one of socket request information for control request or socket request information for data transmission/reception and divides the socket request information.

3. The apparatus of claim 1, wherein the shared memory connecting means includes:
a shared memory driver for performing read/write on transmission/reception data in the shared memory through the set up shared memory connection; and
a socket data processor for setting up shared memory connection through the set up TCP socket connection and controlling read/write of the transmission/reception data of the shared memory driver based on the divided socket request information for data transmission/reception.

4. The apparatus of claim 3, wherein the shared memory driver transmits an event signal on a performance result of read/write of the transmission/reception data in the shared memory to the second socket application program.

5. The apparatus of claim 3, wherein when an error is generated in read/write of the transmission/reception data in the shared memory driver, the socket data processor processes the error generated based on the pre-set up socket select information on read/write of the data.

6. A method for communication interface between application programs on virtual machines, comprising the steps of:
checking a type of socket request information transmitted from a first socket application program on a first virtual machine through a socket interface and dividing the socket request information based on the checked information;
setting up Transmission Control Protocol (TCP) socket connection with a second socket application program on a second virtual machine based on the divided socket request information for control request;
setting up shared memory connection through the set up TCP socket connection; and
transmitting/receiving data with the second socket application program through the set up shared memory connection based on the divided socket request information for data transmission/reception.

7. The method of claim 6, wherein in the step of dividing the request, a type of the socket request information is determined as one of socket request information for control request or socket request information for data transmission/reception and the socket request information is divided.

8. The method of claim 6, wherein in the step of transmitting/receiving the data, read/write of the transmission/reception data is performed in the shared memory based on the divided socket request information for data transmission/reception.

9. The method of claim 8, wherein in the step of transmitting/receiving the data, an event signal on a read/write performance result of the transmission/reception data in the shared memory is transmitted to the second socket application program.

10. The method of claim 8, wherein in the step of transmitting/receiving the data, when an error is generated in read/write of the transmission/reception data, the generated error is processed based on socket selection information which is pre-set up on read/write of the data.
